(19) United States
(12) Patent Application Publication
(10) Pub. No.: US 2011/0282826 A1
(43) Pub. Date: Nov. 17, 2011

(54) Destination Planner in Communication Device

(75) Inventors: Lauren E. Schwendimann, Chicago, IL (US); JoEllen C. Kames, Chicago, IL (US)

(73) Assignee: MOTOROLA, INC., Schaumburg, IL (US)

(21) Appl. No.: 12/779,720

(22) Filed: May 13, 2010

(51) Int. Cl. G06N 5/02

(52) U.S. Cl. 706/54; 706/58; 706/46

(57) ABSTRACT

An electronic device, like a wireless communication device, includes a controller coupled to an interface, wherein the controller is configured to recommend a location or destination based on information about a user of the communication device and based on general destination information. In other embodiments, other recommendations may also be made, for example, a recommended time for traveling to the recommended destination or destination-related resources.

### FIELD OF THE DISCLOSURE

The present disclosure relates generally to communication devices and, more particularly, to interactive destination planning in communication devices, including portable wireless communication devices, and corresponding methods.

### BACKGROUND

Electronic calendar applications are known generally. Such applications include, among others, Microsoft Outlook, which runs on personal computers and mobile communication devices like cellular telephone handsets. These and other electronic calendars permit the user to schedule an appointment on the calendar and to distribute an invitation to potential attendees thereby enabling the coordination and scheduling of appointments. In some networked environments, the calendar application indicates the availability of potential attendees running similar applications before the invitation is sent. The calendar application also permits acceptance or declination of the invitation by invitees.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 is schematic of an electronic device.

FIG. 2 is a schematic process flow diagram.

FIG. 3 is a more detailed process flow diagram.

### DETAILED DESCRIPTION

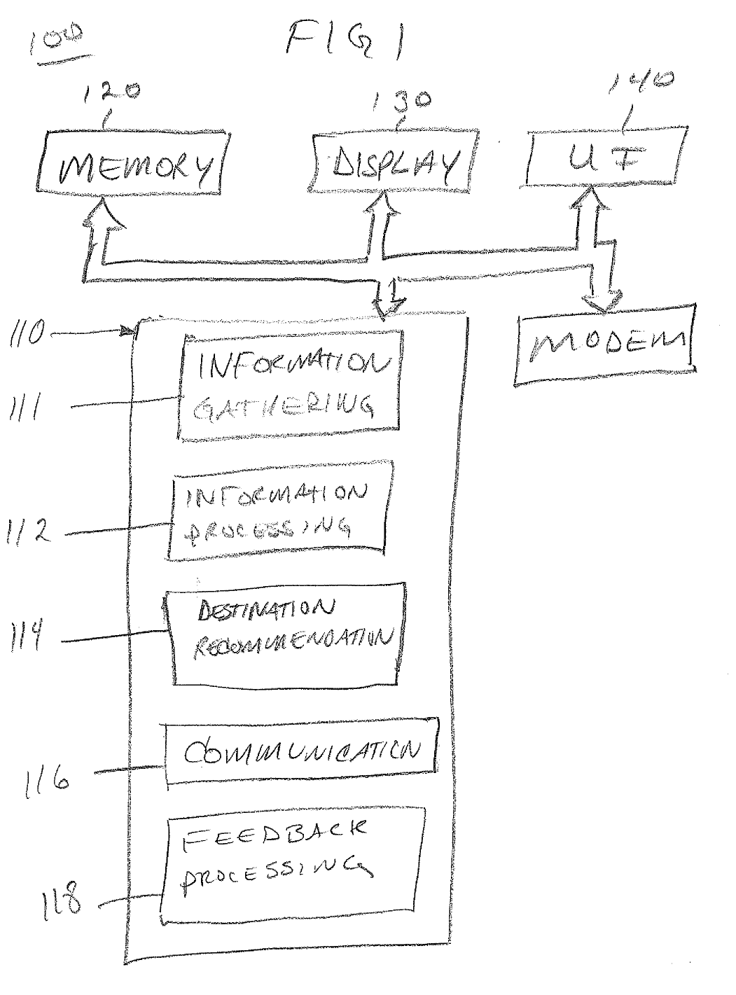

In FIG. 1, an electronic device 100 comprises a controller 110 coupled to memory 120, a display 130, and user interface elements 140. In some embodiments other elements also constitute part of the electronic device, some of which are discussed further below. The user interface elements may include, but are not limited to, a keypad and/or touch screen suitable for inputting alphanumeric and other symbolic characters or information, audio inputs and outputs, and gesture sensors among other user interface elements now know or later developed. The type, location and configuration of the user interface elements, including the display, are not particularly relevant to the subject of the disclosure and thus the particular implementation of the user interface and corresponding user interface elements described herein is not intended to limit the disclosure. Generally the user interface may be considered an information interface, or interface, of the electronic device insofar as information is received by the device at the user interface.

The electronic device may be implemented as a portable device or a relatively fixed station capable of implementing functionality described herein. A portable device may be embodied as a wireless communication handset, a laptop or notebook computer, a portable browsing device, an Internet tablet, or a personal organizer, with or without communications capabilities. A fixed station may be embodied as a personal desktop computer, workstation, or some other relatively immobile electronic device. The particular implementation of the electronic device, portable or otherwise, is manifold and thus the exemplary wireless communication handset described herein is not intended to limit the disclosure.

In one implementation, the electronic device is a communication device having a communication modem, which may be implemented as a wire-line or as a wireless transceiver. In FIG. 1, the electronic device includes a communications transceiver or modem 150. In a more particular implementation, the electronic device is embodied as a portable wireless communication device comprising one or more wireless transceivers. For example, the transceiver may be a cellular transceiver, a WAN or LAN transceiver, a personal space transceiver (e.g., a Bluetooth transceiver), a near field transceiver, a satellite signal transceiver, or some other wireless transceiver. In other embodiments however one or more of the transceivers or modems may be wire-line transceivers. A combination of two or more of such transceivers is also envisaged. The electronic device may also include a satellite positioning system (SPS) receiver (e.g., a GPS, GLONASS or Galileo receiver), a television or radio signal receiver, a one-way communication receiver, or some other receiver. The receiver may be used alone or in combination with one or more communications transceivers as suggested. The transceiver or receiver may be also considered an interface of the electronic device.

In one embodiment, the controller is embodied as a programmable processor that executes firmware or software stored in one or more memory devices wherein the firmware or software enables, implements and controls functionality of the electronic device. The memory may be embodied as one or more discrete devices including, but not limited to, volatile or nonvolatile memory such as random access memory and read-only memory, among other memory devices. In FIG. 1, for example, the controller 110 controls the functionality of the display 130, the user interface elements 140, and the modem 150, among other elements and functionality of the device. In some embodiments, the controller 110 controls or manages other processors that perform dedicated processing tasks. These other processors may include, among other dedicated processors, a video processor that processes video information presented on the display 130, and a baseband processor that processes communication signals communicated to and/or from the communications transceiver 150. Alternatively, the functionality of the electronic device may be implemented by equivalent hardware circuits or modules, or by a combination of software and hardware circuits. The enablement of the basic functionality of electronic devices including wireless communication devices, personal electronic organizers and other portable electronic devices is known generally by those having ordinary skill in the art and is not discussed further herein.

In some electronic devices including a programmable processor, the device also includes an operating system that accommodates one or more software-based applications. In wireless communication handset implementations, for example, the operating system could be embodied as an ANDROID, WINDOWS MOBILE, SYMBIAN or some other proprietary or non-proprietary operating system. In fixed base implementations, the electronic device may also include some other operating system like WINDOWS or a LINUX or UNIX based operating system, among others. More generally, however, the electronic device does not include an operating system per se. In some embodiments, the functionality is controlled by embedded software or firmware and in other embodiments the functionality is implemented by hardware equivalent circuits or a combination of hardware and software controlled circuits. The particular architecture of the operating system and/or processor executable programs and/or hardware that implements and controls the functionality of the electronic device is not intended to limit the disclosure.

According to one aspect of the disclosure the electronic device includes interactive destination planning functionality. In one embodiment, the destination planning functionality is implemented as an application run on or executed by a digitally programmable controller or processer of the electronic device, for example, the controller 110 of FIG. 1. Generally, the interactive destination planning functionality recommends one or more destinations based on information provided to or obtained by the electronic device. Such information is generally provided via the interface of the electronic device, for example, via the user interface, receiver or a data port of the device. In one embodiment, the destination recommendation is based on general destination information and information about at least one participant, e.g., a user of the electronic or communication device. In some embodiments, the interactive destination planner communicates with other devices or services during the destination planning process to obtain information about one or more participants on which the recommendation may be based. In other embodiments, however, the information about the participants is stored locally on the electronic device, thereby eliminating the need for the device to communicate with the other devices during the destination planning process. Such devices may have previously stored information about the participants. The interactive destination planner may also interact directly with participants other than the user, via their respective communication devices, during the destination planning process. In some embodiments, the other communication devices that the interactive destination planner interacts with also include interactive destination planning functionality. In other embodiments, however, the other communication devices with which the interactive destination planner interacts do not include destination planning functionality. It is generally necessary for only one device to include the interactive destination planning functionality.

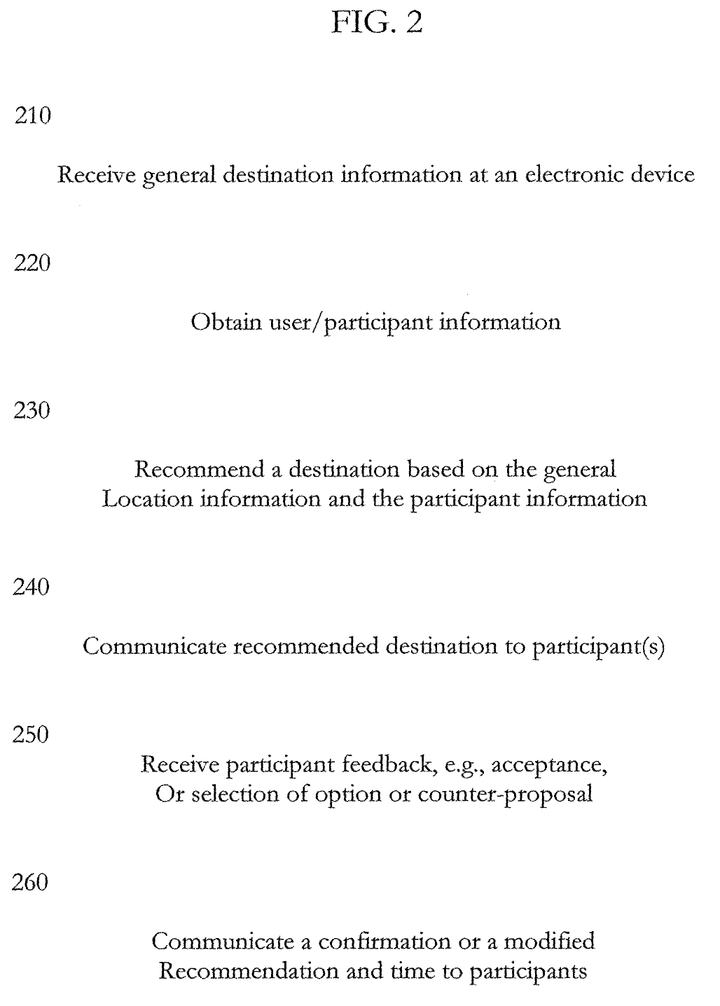

FIG. 2 describes an interactive destination planning process from the perspective of the communication device of the user seeking a destination recommendation. In FIG. 2, at 210, the algorithm receives general location or destination information, usually upon the user inputting information into the electronic device at a user interface. The general destination information may be as broad as identifying a geographical region or as narrow as identifying a provincial or politically specified area. For example, a geographical region may be specified as Eastern Europe, Mediterranean Coast, New England region of North America, Caribbean, etc. A provincial area may be specified as New York City, North side of Chicago, Los Angeles, etc. The general destination information may also be specific to a particular location within a village or municipality, for example, North Michigan Avenue, Monterey Beaches, the identification of a particular shopping center, a particular neighborhood (e.g., Greenwich Village, Ravenswood Manor,) etc. The general destination may also be specified in terms of general reference coordinates, e.g., latitude, longitude and elevation coordinates. The user may input the information audibly or by tactile interaction with the electronic device. Alternatively, the algorithm may obtain the general destination information from another application running on the device. For example, the general destination information may be obtained from a map or navigation application or electronic document or file by selecting and exporting or pasting the selection. The algorithm may also obtain the general destination information from some other device or entity communicably connectable to the electronic device.

In FIG. 2, at 220, the interactive destination planning algorithm obtains or receives participant information, which may be obtained locally or from a remote source as described further below. The user may input this information at the user interface of the device. The participant information generally identifies an entity, for example, an individual or a group of individuals that may be interested in the destination recommended by the interactive destination planner. The participant information may also be exported manually or automatically from some other application or device. In some instances both the general destination information and the participant information are obtained from a common application or other common source. In FIG. 1, the controller 110 is configured to execute or implement information acquisition functionality 111 by instructions stored in memory. While FIG. 1 characterizes the information acquisition as functionality performed by a programmed processor, equivalent functionality may also be performed by an equivalent hardware circuit or module. In another embodiment, the algorithm recommends the location based on tentative time information received at the interface. Such information may be provided by the user or the algorithm may obtain the tentative time information from another source. In some embodiments, more generally, the controller obtains other information, not necessarily input by the user, for use in the destination planning process as described further below. In FIG. 2, the order in which the general destination information and the participant information is input to or obtained by the communication device and particularly the destination planning algorithm is not particularly relevant.

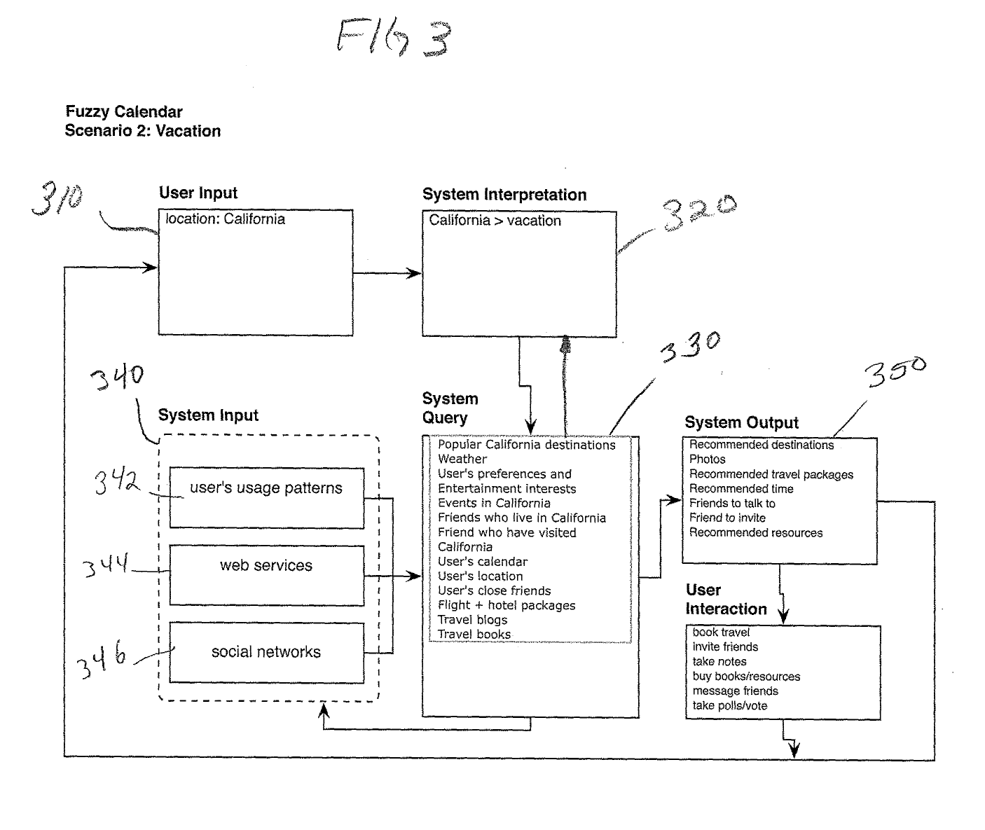

In the more detailed process diagram 300 of FIG. 3, at 310, general destination information is input to, or otherwise obtained by, electronic device. At 320, the interactive destination planning algorithm interprets the general destination information. Generally, the controller processes the information input at 310 and any other information before making a destination recommendation. Other information that is or may be considered by the algorithm is described further below. For example, the controller may determine preferences of one or more participants, e.g., a user of the communication device, possibly interested in the general destination input at 310. More specific examples of information that may be obtained and processed as part of destination planning are described below. Thus any information that is considered in the destination planning process is also interpreted or processed by the controller at 320. This processing functionality may be enabled by programmed instructions stored in memory and executed by a processor. Thus in FIG. 1 the controller 110 is configured to execute or implement information processing functionality 112 by instructions stored in memory. While FIG. 1 characterizes information processing as functionality performed by a programmed processor, equivalent functionality may also be performed by an equivalent hardware circuit or module.

In FIG. 2, at 230, the interactive event scheduling algorithm implemented by the controller recommends a destination based on the general destination or location information and the participant information. The algorithm may also recommend a proposed time at which the user or participants may travel to the recommended destination. The proposed time may be based upon tentative time information provided by the user or otherwise obtained by the communication device. Alternatively, multiple destinations, and possibly multiple tentative times, may be recommended. In FIG. 1, the controller 110 is configured to implement or execute destination recommendation functionality 114 by instructions stored in memory. While FIG. 1 characterizes the recommendation functionality as being performed by a programmed processor, equivalent functionality may also be performed by an equivalent hardware circuit or module.

Generally, the one or more destinations recommended are based on preference information for the user of the device and/or based on preference information of any other participants. The preference information is meant to include user or participant preferences, as well as participant characteristic or profile information, e.g., gender, orientation, occupation, interests, dislikes, etc., among any other information that may be available to the algorithm and with which the algorithm may use as a basis for making a recommendation. The preference information may be provided to the algorithm by the user seeking the destination recommendation. Alternatively, the algorithm may query a local or remote repository for such information. The algorithm may also give consideration to past or historical participant interaction related to or independent of the general destination.

In FIG. 3, at 330, the algorithm implemented or executed by the controller may perform one or more queries to identify the preference information for the user and/or for the other participant(s). This information may then be made available for interpretation and processing at 320. Generally, the controller may obtain the preference information from one or more of many different sources 340 external to the communication device. However some of this information may also be stored locally on the communication device. While some preference information may be stored locally on the communication device for some participants, more information may be available from remote or external sources. FIG. 3 identifies several exemplary external sources from which the controller may obtain relevant preference information. The preference information may include, but is not limited to, participant usage or behavior patterns 342, web services 344, and social networks 346, among others. Exemplary social networks from which the preference information may be obtained include Facebook, Myspace and LinkedIn, among other networks. Other social networks from which participant preference information may be obtained include music networks like LastFM and I-Like. Yelp! is a recommendation network that may also be a source of participant preference information. These exemplary participant preference sources are not intended to be inclusive or to limit the disclosure. In FIG. 1, access to remote information repositories is performed by the information acquisition functionality 111.

As suggested, some of the preference information may be accessible to the algorithm as profile information stored locally on the communication device. The profile information may include name, age, gender, interests, location, favorites (e.g., music movies, or other media, websites, restaurants, sports, teams, etc), usage patterns, memberships, medical information, among other information and combinations thereof. The profile information may also include dynamically changing information about the participant, e.g., location, mental or emotional disposition etc., some examples of which are discussed further below. This and other profile information may be input manually or it may be obtained locally or from a remote source, like a social network or some other network-based source of information, examples of which are also described herein.

In one embodiment, the algorithm executed by the controller determines one or more interests or preferences of the participant or user of the communication device and then recommends one or more destinations based on the preferences and any other information that may be considered. For example, if the participant is interested in wine tasting and the general destination is California, the algorithm may recommend one of the grape growing regions as a destination. In instances where multiple participants are considered, the algorithm may base the recommendation on interests or preferences common to the multiple participants. Another criterion applicable to multiple participants is the availability of the participants during a time frame during which travel to the destination is contemplated. For example, whether the participants are both available during a tentative time period considered by the destination planner. The recommendation may be more particular if more detailed information is available to the algorithm making the recommendation. With respect the example described above, for example, the algorithm may also recommend one or more particular accommodations, e.g., hotels, resorts or cities, in proximity to wineries known to produce varieties appealing to the tastes of the participant. The recommendation may also be sufficiently specific to include an event, like a wine tasting Festival, at or near the recommended location. The recommendation of an event may also be based on information about the user or participant to whom the recommendations are made. Also, if multiple destinations satisfy preferences common to the one or more participants, the destination planner may recommend more than one destination. The algorithm may also prioritize multiple recommended destinations. Other examples are described below.

The availability of the participants could be based solely on tentative time information provided initially or based on more specific availability information obtained from the parties in response to the recommended destination. More specific availability information could be based on specific times that the participants are available within a tentative time range initially provided to or obtained by the algorithm. More specific participant availability information may be later obtained from the participants, for example, from calendar applications or from social networks where the participants make their schedules available. The participants may also provide more specific availability information in response to a query generated by the algorithm and communicated to the participants by electronic device. Under these circumstances, the communication device hosting the destination planning algorithm is in communication with the communication device of at least one other participant during the planning process.

In other embodiments where multiple participants are intent on traveling to a recommended destination, one or more preferences of the participants are used as a basis for recommending the one or more destinations. For example, if the participants are business or professional colleagues, the recommended destination may be different than if the participants are personal friends or recent acquaintances. Similarly, a different destination may be recommended for participants interested in hiking and climbing than for professional colleagues or honeymooners. Thus, generally, more detailed and uniquely tailored recommendations may be made where more particular participant preference information is made available to the interactive destination planning algorithm.

In another embodiment, the controller obtains state of mind information about the one or more participants, and recommends a destination based at least partly on the state of mind information. The state of mind information could be an emotional disposition or the mood of the participants. This information may be made available and updated regularly on some social networks and in other venues accessible to the destination planner algorithm. The state of mind may be characterized as “happy”, “sad”, “energized” “depressed”, “stressed”, “ecstatic”, “busy” among many other states that can be described and made accessible to the algorithm. According to this embodiment, the state of mind may be accessed and used as preference information for the purpose of recommending a destination. For example, the recommended destination may be a relaxing resort if the parties are “fatigued”, or it could be a surfing destination if the participant is “energized”. The state of mind preference may be used in isolation or in combination with other preference information. In FIG. 1, this state of mind preference information is obtained by the information acquisition functionality 111.

Generally, the one or more recommendations are communicated to at least one of the participants, typically the user seeking the destination recommendation. In FIG. 2, the process diagram illustrates such a communication at 240. In FIG. 3, at 350, the system outputs the recommended destination and other information. This may include the communication of the recommendation to the participants. In some embodiments, the algorithm may also provide directions or routing information to the recommended destination. Other recommendations that may be made in association with the destination recommendation include recommended travel packages, other friends or participants to invite, etc. Other recommendations that may be made include resources related to the recommended destination. Such resources may include local maps, entertainment guides, weather and other information, etc.

Generally, the one or more destination recommendations and other recommendations are communicated to the user and possibly to the other participants. The recommendation may be communicated to the user of the device on which the destination planning occurs at the user interface of the device and/or via a message. The recommendation may also be communicated to other participants or invitees. Such a message may be an e-mail message or some other electronic message like a text message or an instant message (IM) or an electronic meeting invitation typical of some calendar applications. For such messaging to occur, in some implementations, the destination planning algorithm includes messaging functionality or the algorithm it is interfaced to a separate messaging application, like an e-mail or IM application or to a calendar application like MICROSOFT OUTLOOK. In FIG. 1, the controller 110 is configured to implement or execute communication functionality 116 by instructions stored in memory. While FIG. 1 characterizes the communicating functionality as being performed by a programmed processor, equivalent functionality may also be performed by an equivalent hardware circuit or module.

In response to the communication of the destination and other recommendations, the one or more participants may provide feedback with which the interactive destination planner may generate and communicate one or more updated recommendations. The original recommendation may thus be refined or revised. In FIG. 2, at 250, the algorithm receives feedback from the participants. The participant feedback may be a mere acceptance of a recommendation. If all participants accept the recommendation, the algorithm may in some embodiments communicate a confirmation notification. In FIG. 2, at 260, the algorithm communicates a confirmation to the participants if the participants accept the recommendation. In some embodiments, upon confirmation, the algorithm may schedule the destination and time in a calendar or other application for the one or more participants. The destination algorithm may be a part of a calendar application or the calendar application may be separate.

In some embodiments, the algorithm refines the initial destination and other initial recommendations based on the feedback provided by one or more participants. According to this mode of operation, the algorithm recommends a new destination and other new recommendations, e.g., new time a different set of participants, based on the feedback. In FIG. 1, the controller 110 is configured to implement or execute updated recommendation functionality at 114 by instructions stored in memory. The revised recommendation is then communicated to the participants, which can then accept, decline or propose new terms. The iteration may be continued and further revised or refined until the participants ultimately accept or decline. In one use case, the feedback provided by the participants is in the form of a prioritization of several destinations recommended by the algorithm. Based on such feedback, the algorithm may recommend one of the prioritized destinations, giving consideration to any feedback provided by other participants. The participants may also provide feedback by selecting one of several destinations and other recommends by the algorithm. Alternatively, the participants may propose a new or alternative destination than that recommended. The feedback provided by the participants may also be in the form of a prioritization of several items recommended by the algorithm. Based on such feedback, the algorithm may recommend one of the prioritized items giving due consideration to any item-related feedback provided by the other potential participants. The participants may also select one of several items recommend by the algorithm and feedback the selected time. Alternatively, the participants may propose a new or different item than the item or items recommended. In FIG. 1, the controller 110 is configured to implement or execute participant feedback processing functionality at 118 by instructions stored in memory. While FIG. 1 characterizes the feedback processing functionality as being performed by a programmed processor, equivalent functionality may also be performed by an equivalent hardware circuit or module.

While the present disclosure and the best modes thereof have been described in a manner establishing possession by the inventors and enabling those of ordinary skill to make and use the same, it will be understood that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A communication device comprising:
an interface;
a controller coupled to the interface,
the controller configured to recommend a location within a general destination in response to receiving general destination information at the interface,
the recommended location based on information about a user of the communication device and based on the general destination information.

2. The device of claim 1, the controller configured to recommend the location based on tentative time information received at the interface.

3. The device of claim 1, the controller configured to recommend a time frame in association with the recommended location based on information about the user of the communication device.

4. The device of claim 1, the controller configured to recommend a participant in association with the recommended destination.

5. The device of claim 4, the controller configured to recommend the destination based on information about the participant.

6. The device of claim 5,
the controller configured to obtain preference information for the participant other than the user of the communication device,
the controller configured to recommend the location based on the preference information for the participant.

7. The device of claim 6 further comprising a transceiver coupled to the controller, the controller configured to obtain the preference information from a remote information source via the transceiver.

8. The device of claim 6, the controller configured to recommend a time frame in association with the recommended location based on information about the user of the communication device and the participant.

9. The device of claim 1, the controller configured to obtain feedback from the user of the communication device and to recommend a revised location based on the feedback.

10. The device of claim 1, the controller configured to recommend location resources based on the recommended location.

11. A method in a communication device, the method comprising:
receiving, at the device, general destination information;
recommending, by the device, a location,
the location recommended based on information about a user of the communication device and based on the general destination information.

12. The method of claim 11 further comprising obtaining, at the device, tentative travel time information, wherein the location recommendation is based on the tentative travel time information.

13. The method of claim 11 further comprising obtaining information about the user of the communication device, the controller configured to recommend a time frame in association with the recommended location based on the information about the user of the communication device.

14. The method of claim 11 further comprising recommending a participant in association with the recommended destination.

15. The method of claim 14 recommending the destination based on information about the participant.

16. The method of claim 15 further comprising obtaining preference information for the participant, wherein the location recommendation is based on the preference information for the participant.

17. The method of claim 16 further comprising recommending a time frame in association with the recommended location based on information about the user of the communication device and the participant.

18. The method of claim 11 further comprising obtaining feedback from the user of the communication device and recommending a revised location based on the feedback.

19. The method of claim 11 further comprising recommending location resources based on the recommended location.
